(19) United States
(12) Patent Application Publication
(10) Pub. No.: US 2006/0288954 A1
(43) Pub. Date: Dec. 28, 2006

(54) Dispensing wash mitt with refillable shampoo cartridges

(75) Inventor: Joseph Graunstadt, Norwalk, CT (US)

Correspondence Address: GOTTLIEB RACKMAN & REISMAN PC, 270 MADISON AVENUE, 8TH FLOOR, NEW YORK, NY, 100160601, US

(73) Assignee: The Hartz Mountain Corporation

(21) Appl. No.: 11/231,717

(22) Filed: Sep. 20, 2005

Related U.S. Application Data
(60) Provisional application No. 60/694,495, filed on Jun. 28, 2005.

(51) Int. Cl. A01K 29/00

(52) U.S. Cl. 119/652

(57) ABSTRACT

A dispensing wash mitt for pets or humans includes a hand receiving mitt having a top side and a mitt palm side providing a finger receiving cavity. A mitt scrubbing member is attached to the mitt palm side, said mitt scrubbing member having a plurality of holes disposed from one side of the mitt scrubbing member to the other side. The mitt scrubbing member, when attached to said mitt palm side, defines a pocket which receives a replaceable cartridge that is selectively insertable into the pocket for dispensing shampoo or other material through the holes in the scrubbing member for application to the pet or human.

This application claims the benefit of Provisional Application Ser. No. 60/694,495, filed Jun. 28, 2005.

### BACKGROUND

Rubber shampoo mitts are used to massage the pet while washing. Typically, shampoo is applied directly to the pet via bottle or tube. Washing is done with a separate shampoo bottle and mitt. Shampoo is reapplied during washing as necessary. This creates a concentration of shampoo in one area.

Various prior art devices have been contemplated for providing a mitt or other hand device for dispensing shampoo or other material.

In the pet grooming field, the patent to Rampersad, U.S. Pat. No. 6,109,214, discloses a pet grooming rubber mitt with a built in reservoir for dispensing shampoo. The reservoir extends along the entire mitt. Shampoo is dispensed from the mitt through knife slits distributed over the palm surface of the mitt. The slits remain close when the mitt is flat, but open when the mitt is curled to dispense the shampoo. Although this patent discloses the broad concept of a shampoo mitt, it is nonetheless unsatisfactory in several respects. First, it is made substantially entirely of hard rubber and would not be particularly comfortable to wear. Second, shampoo is dispensed only when the mitted is curved. As such, the shampoo is not distributed evenly along the washing surface of the mitt. Third, shampoo must be dispensed into the reservoir through a relatively small aperture which then must be kept closed by a stopper, creating the possibility of spillage as the reservoir is filled.

The patent to Salisian, U.S. Pat. No. 5,704,723, discloses a soap dispensing device in the form of a sponge which holds a liquid soap sack having microscopic sized pores. When the sponge is immersed, the soap mixes with the water, diluting the soap, which is then available at the sponge. Salisian does not indicate that his device is for use in the pet grooming field. Moreover, the structure requires immersing the sponge in water in order for the soap to be dispensed. Accordingly it is also structurally complex as it requires water to be able to flow into the pouch and, when the soap is eventually available for use, it is in a diluted form.

### OBJECTS OF THE INVENTION

It is therefore an object of the present invention to provide a new and improved dispensing wash mitt.

It is a further object of the invention to provide a dispensing wash mitt which can be readily filled while, at the same time, providing full strength of the material to be dispensed.

It is another object of the invention to provide a dispensing wash mitt which can selectively receive various dispensing cartridges so as to provide a range of material to be dispensed. Moreover, the consumer can purchase a variety of formulas to use without having to buy a full size bottle of shampoo.

A still further object of the invention is to provide a dispensing wash mitt that enables shampoo or other grooming material to be dispensed at a slow and controlled rate, allowing for even spreading of the shampoo, while bathing or grooming pets.

Yet a further object of the invention is to provide a system that does not require re-application of shampoo.

Another object of the invention is to provide a system that does not waste shampoo and decreases the amount of time it takes to wash the pet.

### SUMMARY OF THE INVENTION

The present invention includes a mitt having a palm side and a scrubbing member disposed adjacent to the palm side. The palm side of the mitt and the scrubbing member provide a pocket for receiving shampoo or other grooming material. The material is contained in a replaceable, disposable cartridge which, preferably, is in the form of a flexible plastic pouch having a label that can be peeled away to expose holes in the pouch, thereby enabling the shampoo or other material in the pouch to drain out as the pet is groomed. The scrubbing member includes a plurality of nibs for washing or grooming a pet, and a plurality of holes for allowing the soap or grooming material to reach the pet. The mitt enables shampoo or other grooming material to be dispensed at a slow and controlled rate, allowing for even spreading of the shampoo, while bathing or grooming pets.

### BRIEF DESCRIPTION OF THE DRAWINGS

The present invention can best be understood in conjunction with the following drawings, in which:

FIG. 1 is a front view of the mitt of the present invention;

FIG. 2 is a cross-sectional taken along line 2-2 of FIG. 1, and slightly enlarged in scale;

FIG. 3 is an exploded view of the mitt of the present invention, showing the pocket formed in the mitt and a cartridge disposed within the pocket;

FIGS. 4-6 are front elevational views of cartridges for use in the mitt of the present invention;

FIG. 7 is a front view of an alternative embodiment of the mitt of the present invention with an irremovable pocket having an access opening for receiving the cartridge; and

FIGS. 8-9 are cross sectional views, enlarged in scale, taken along lines 8-8 and 9-9 of FIG. 7, respectively.

### DETAILED DESCRIPTION OF THE INVENTION

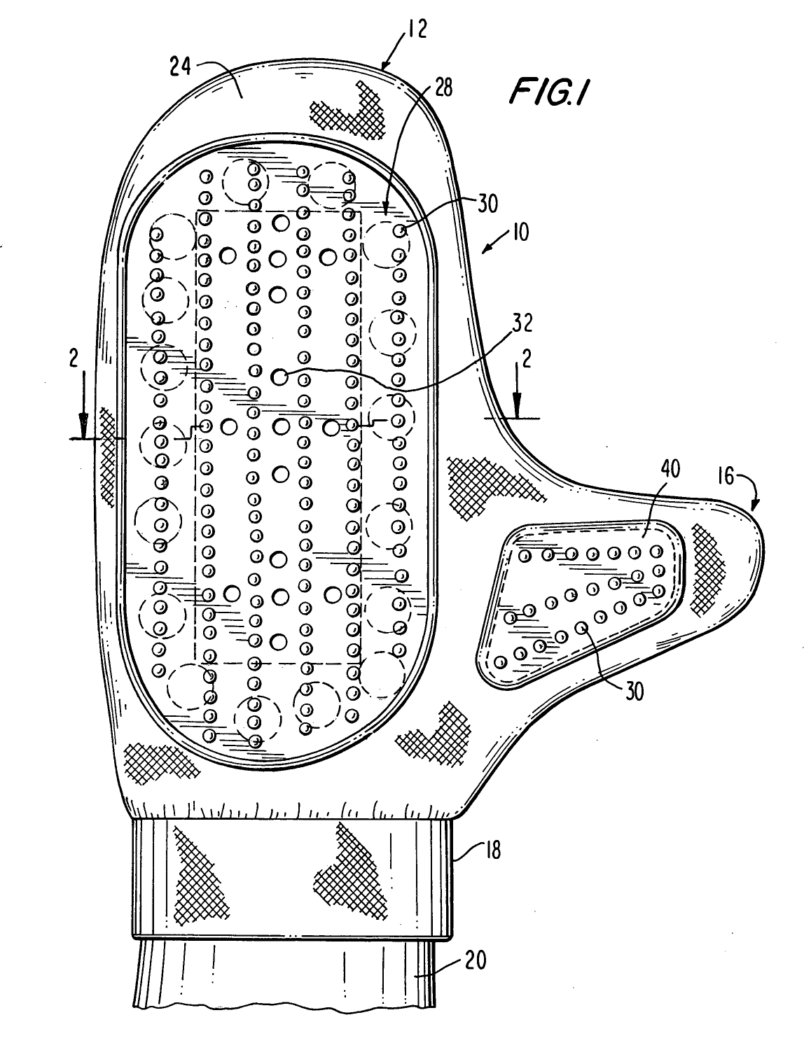

Referring now to the drawings and, more particularly, to FIGS. 1-3 thereof, a dispensing wash mitt 10 according to the present invention is shown. Mitt 10 has a finger receiving portion or cavity 12 which is sized to receive the fingers 14 of a user. Mitt 10 also has a thumb receiving portion 16 for receiving a user's thumb (not shown). A cuff 18 is disposed at the opening of mitt 10 for accommodating the forearm 20 of the user near the user's wrist. The mitt is advantageously made of a non-porous, plastic material capable of being injection molded.

Mitt 10 has a top or knuckle side 22 which is located adjacent a user's knuckles and a bottom or palm side 24 which is located adjacent the user's palm when the user's fingers are inserted. The top 22 and bottom 24 of mitt 10 are fastened together, for example, at sewing seam 26, to define the finger receiving cavity.

Mitt 10 also includes an elongated palm scrubbing member 28 which is attached to mitt palm side 24. Mitt scrubbing member 28 includes a plurality of nibs 30 for scrubbing the pet. Mitt scrubbing member 28 also has a plurality of holes 32 going through the scrubbing member from one side to the other, for enabling shampoo or other material to be dispensed from mitt 10, as will be explained.

In the embodiment shown in FIGS. 1-3, mitt scrubbing member 28 is attached to palm side 24 of mitt 10 by fastening members 34. Fastening members 28 may be made of Velcro, with certain of fastening members 36 secured to mitt palm side 24 and other fastening members 38 secured to mitt scrubbing member 28. This enables mitt scrubbing member 28 to be removably secured to mitt palm side 24. Mitt 10 also includes a thumb scrubbing member 40 which is permanently attached to thumb receiving portion 16, by stitching, gluing or the like. Like mitt scrubbing member 28, thumb scrubbing member 40 includes nibs 30 for facilitating scrubbing of the pet.

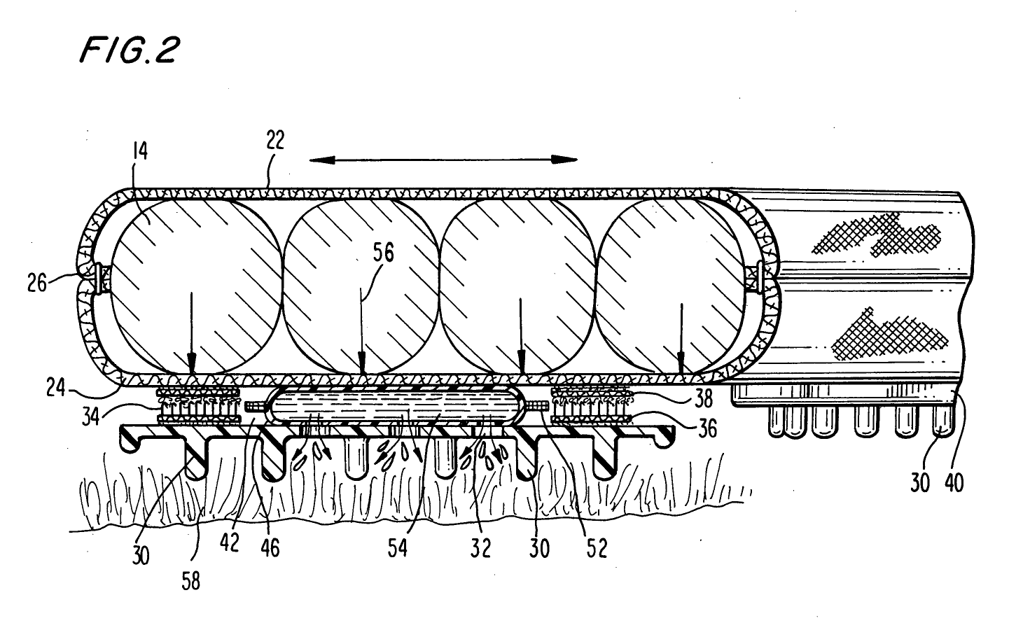

When attached to each other, mitt scrubbing member 28 and mitt palm side 24 define a pocket 42. Pocket 42 is sized to securely receive a flexible, disposable cartridge 44. As shown in FIG. 2, disposable cartridge 44 advantageously takes the form of a plastic pouch 46. A peelable label 48 covers holes 50 formed in one side of pouch 46. The holes are absent from the other side of pouch 46. The edges 52 of pouch 46 are sealed. A predetermined amount of shampoo or soap 54 is inserted in pouch 46, prior to edges 52 being sealed. The pouch is advantageously made of a flexible, plastic material. Until label 48 is removed, the shampoo (or soap) remains within pouch 46.

When it is desired to shampoo a pet, the user separates mitt scrubbing member 28 from mitt palm side 24, by pulling against Velcro members 36 and 38. Peelable label 48 is removed from pouch 48 and discarded. Pouch 48 is then inserted between scrubbing member 28 and palm side 24, with holes 50 of the pouch facing the mitt scrubbing member. Mitt scrubbing member 28 and mitt palm side 24 are then reattached, one to the other, with pouch 48 being maintained within pocket 42 of mitt 10.

When it is desired to groom or wash the pet, the user applies pressure in the direction of arrows 56, thereby enabling shampoo or soap 54 to be dispensed evenly through pouch holes 50 and through holes 32 of mitt scrubbing member 28, for application to the fur or skin 58 of the pet.

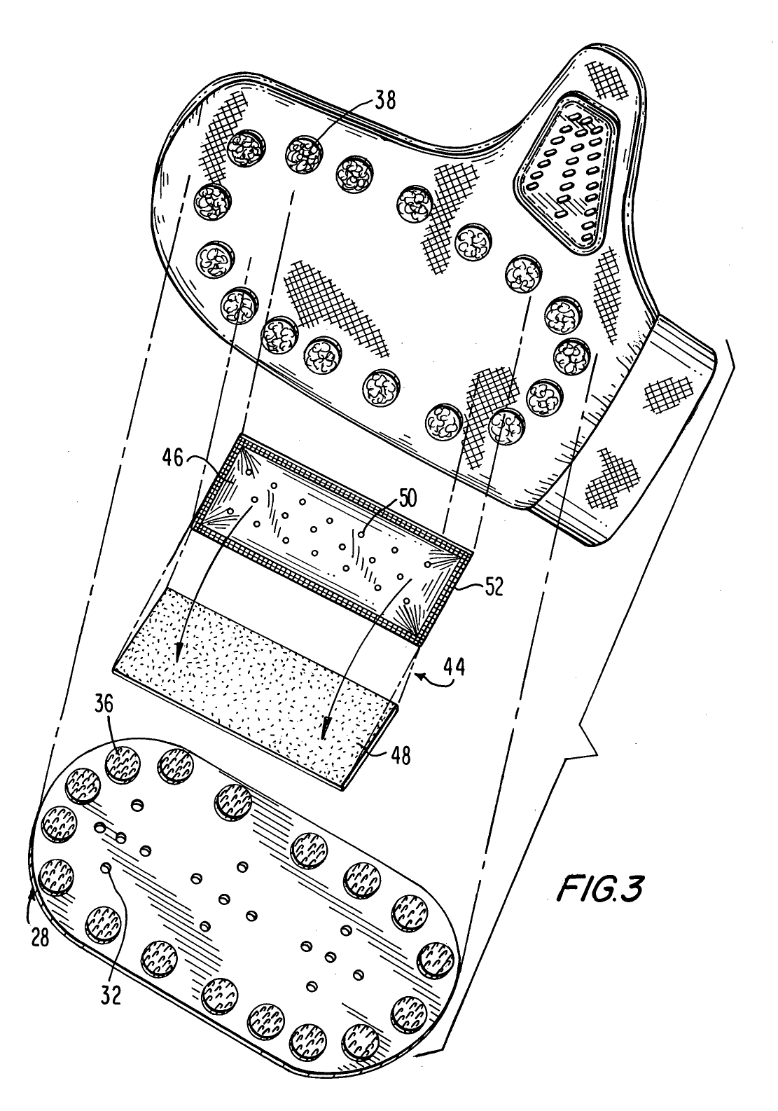

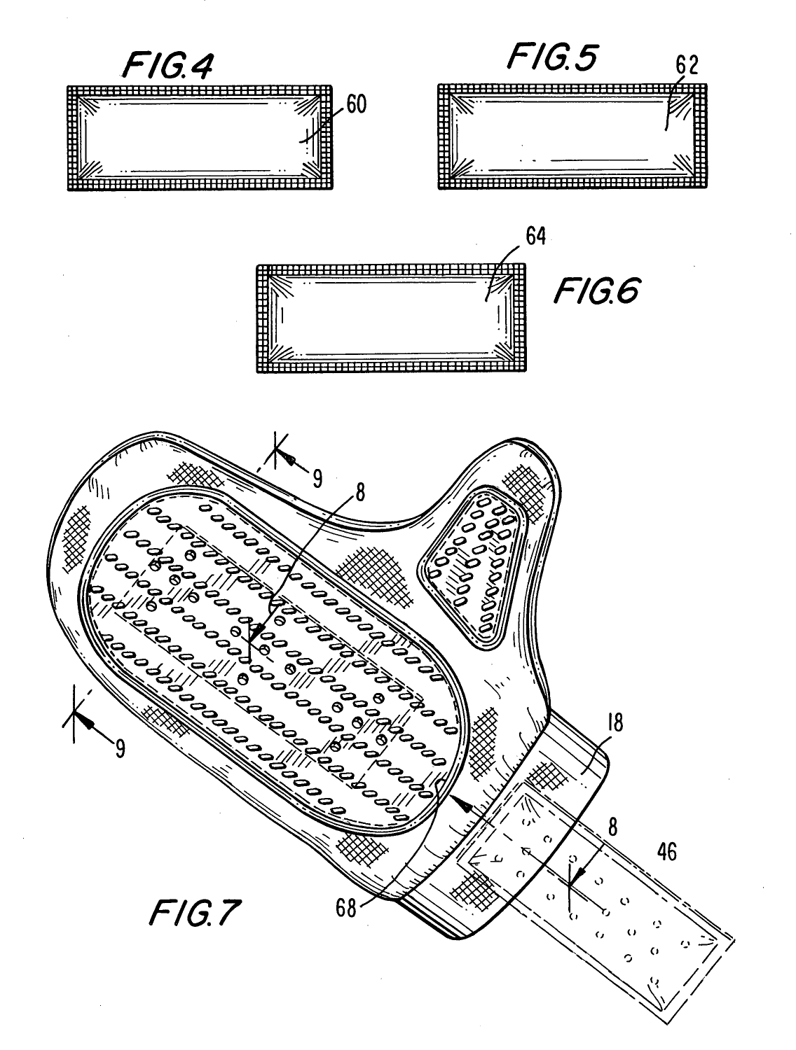

FIGS. 4-6 show different pouches, 60, 62 and 64, which may contain different materials. For example, pouch 60 may contain medicine, pouch 62 may contain shampoo or soap of one formula and pouch 64 may contain conditioner, or shampoo or soap of another formula.

By using mitt 10, shampoo or other grooming material can be dispensed at a slow and controlled rate, allowing for even spreading of the shampoo, while bathing or grooming the pet.

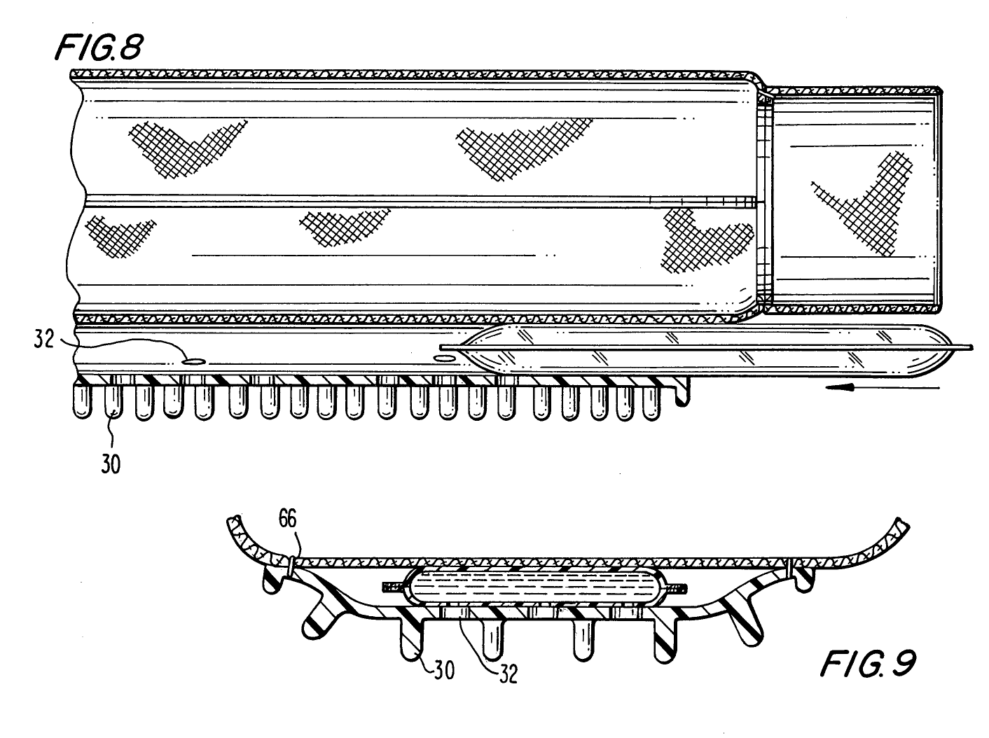

FIGS. 7-9 show an alternative embodiment of the present invention. In this embodiment, mitt scrubbing member 28 is permanently connected to mitt palm side 24, for example, by stitching 66 along at least three sides of the mitt scrubbing member disposed at the edge thereof. The stitching stops along the edge of the mitt scrubbing member adjacent cuff 18 so as to provide an opening 68. The user slides pouch 46 through opening 68, in order to insert the pouch into pocket 42. When grooming is over, the user reaches into pocket 42 and removes the spent pouch through opening 68.

It will be appreciated that modifications may be made to the present invention. For example, similar mitts, using different materials contained within plastic pouch 46, could be used for humans. By way of example, body wash, conditioner, shampoo with conditioner, and/or dandruff shampoo could be one of the dispensed materials. Similarly, a capsule could be inserted into a “scrubby” before washing. Slight pressure could “pop” the capsule and washing could begin. The advantage to humans is the ability to purchase a variety of capsules or cartridges with different formulas, thereby eliminating the need for multiple bottles of shampoos, body washes and conditioners or the like.

Similarly, a pressurized pouch could also be used. The system would be activated by the mere push of a button, so that the mitt scrubbing member would “foam up” with shampoo or soap.

What I claim is:

1. A dispensing wash mitt, for pets or humans comprising:
a hand receiving mitt having a top side and a mitt palm side for defining a finger receiving cavity;
a mitt scrubbing member attached to said mitt palm side, said mitt scrubbing member having a plurality of holes disposed therethrough from one side of said mitt scrubbing member to the other side of said mitt scrubbing member;
wherein said mitt scrubbing member and said mitt palm side define a pocket; and
a replaceable cartridge selectively insertable into said pocket for dispensing shampoo or other material through said holes in said mitt scrubbing member for application to the pet or human.

2. A dispensing wash mitt according to claim 1, wherein said mitt scrubbing member is selectively attached to and removable from said mitt palm side.

3. A dispensing wash mitt according to claim 1, wherein said mitt scrubbing member is permanently attached to said mitt palm side, said mitt scrubbing member and said mitt palm side defining an opening for access to said pocket.

4. A dispensing wash mitt according to claim 1, wherein said replaceable cartridge includes a pouch having a plurality of holes for enabling said shampoo or other material to exit said pouch.

5. A dispensing wash mitt according to claim 4, wherein said cartridge includes a peelable label which covers said plurality of holes in said pouch, said label removable from said pouch prior to the time said pouch is inserted into said pocket.

6. A dispensing wash mitt according to claim 5, wherein said pouch is receivable within said pocket with said plurality of holes of said pouch adjacent to said holes of said scrubbing member.

7. A dispensing wash mitt according to claim 6, wherein said pouch has a first side formed with said plurality of holes and a second side devoid of any holes.

8. A dispensing wash mitt according to claim 1, wherein two or more cartridges are provided, with each cartridge having a different material contained therein.
